(19) United States
(12) Patent Application Publication
(10) Pub. No.: US 2013/0104457 A1
(43) Pub. Date: May 2, 2013

(54) BATCH MODE SUPPLY OF FEEDSTOCK IN A NON-COMBUSTIVE GASIFICATION SYSTEM

(71) Applicants: Roger Jorgenson, Swanton, OH (US); Robb Alexander Johnson, Maumee, OH (US); Douglas Struble, Maumee, OH (US)

(72) Inventors: Roger Jorgenson, Swanton, OH (US); Robb Alexander Johnson, Maumee, OH (US); Douglas Struble, Maumee, OH (US)

(73) Assignee: RED LION BIO-ENERGY TECHNOLOGIES, Maumee, OH (US)

(21) Appl. No.: 13/282,054

(22) Filed: Oct. 26, 2011

(51) Int. Cl. B01J 7/00; C10J 3/00

(52) U.S. Cl. 48/61; 48/197 R

(57) ABSTRACT

Batch mode supply of feedstock in non-combustive gasification systems and methods are described. In accordance with an aspect, a feedstock material is injected into a vessel at atmospheric pressure, atmosphere from the feedstock material in the vessel is purged, the purging includes evacuating the vessel, and in response to the pressure level in the vessel being below a predetermined value, injecting synthesis gas generated in a non-combustive gasification system, the vessel is pressurized to a reference pressure greater than an operating pressure of a gasification chamber, a portion of the feedstock material is supplied to an accumulation chamber, further feedstock material is injected into the gasification chamber, and atmospheric pressure in the collection vessel is recovered.

### TECHNICAL FIELD

The subject disclosure relates to production of bio-fuel from feedstock and, more specifically, to supplying feedstock in batch mode to a non-combustive gasification system.

### BACKGROUND

A convergence of various financial factors, such as increase in fossil fuel costs; market forces (e.g., adherence to sustainable energy consumption paradigms); and geopolitical conditions (instability in oil-rich regions, climate change, etc.) has renewed interest in gasification of organic or carbonaceous materials, often called feedstock or feedstock material, to generate combustible synthesis gas (or syngas) for renewable generation of fuel. Synthesis gas can be utilized to generate electricity with reduced CO₂ emissions compared to electricity derived from fossil fuel. In addition, feedstock utilized for generation of synthesis gas is largely encompassed by post-processed (organically or synthetically) waste; therefore, feedstock is intrinsically sustainable.

Amongst various gasification processes commonly employed for generation of synthesis gas is pyrolysis. Such process produces by-products, such as chars or tars, in addition to production of synthesis gas. In conventional gasification systems, the feedstock is dried and supplied into a stirred, heated kiln. As the feedstock passes through the kiln, combustible synthesis gas is produced and is continuously removed from the kiln. However, production of synthesis gas in conventional gasification systems is generally inefficient, with an energy balance that renders production of fuel or electricity derived thereof commercially non-viable. In addition, conventional processes generally exacerbate commercial viability issues with elevated operational costs associated with process inefficiencies related to manipulation of produced by-products. In addition, poorly designed management of the by-products also result in synthesis gas of lesser quality, with ensuing low quality of derived fuels and ensuing limited commercial thereof.

Conventional gasification systems also can implement combustive or partially combustive gasification processes to render feedstock into synthesis gas and by-products. Partially combustive processes can account and compensate for introduction of atmosphere (e.g., air and other gases) into a gasification system by regulating combustion air that is injected into the gasification system. Moreover, conventional gasification systems that exploit partially combustive gasification process(es) generally operate at a lower temperature that gasification systems that exploit non-combustive process(es).

In conventional gasification systems that exploit non-combustive gasification process(es) and moisture is retained in the supplied feedstock, fugitive steam (or steam that flows backwards with respect to flow of supplied feedstock) can originate from elevated temperatures associated with gasification chambers in which at least part of the gasification process is conducted. Moreover, in conventional systems that rely on partially combustive process(es), fugitive steam can lead to caking of feedstock material and possible related clogging of equipment or structure that are part of such systems. Clogging originating from fugitive steam also can affect gasification systems that relay on non-combustive gasification process(es).

### SUMMARY

The following presents a simplified summary of the subject disclosure in order to provide a basic understanding of some aspects thereof. This summary is not an extensive overview of the various embodiments of the subject disclosure. It is intended to neither identify key or critical elements nor delineate any scope. Its sole purpose is to present some concepts in a simplified form as a prelude to the more detailed description that is presented later.

One or more embodiments provide system(s) and process(es) to supply feedstock in batch mode to a non-combustive gasification system. Feedstock delivery includes a set of stages comprising a plurality of stages that can be effected in various orders. One stage includes injection of feedstock material into a collection vessel at atmospheric pressure. The collection vessel can be embodied in an air-lock system and includes at least two air-lock valves that regulate entrance and release of feedstock. Another state includes removal of atmosphere from the feedstock material contained in the collection vessel. Such removal stage can include evacuation (e.g., generation of a vacuum state) of the collection vessel, and circulation of synthesis gas generated in a non-combustive gasification system comprising the collection vessel. In an aspect, the synthesis gas is circulated in response to achieving a predetermined vacuum condition (e.g., pressure level below atmospheric pressure) in the collection vessel.

Yet another stage includes pressurization of the collection vessel. Synthesis gas enables the pressurization. In a scenario, pressurization is effected until at least a pressure greater than operating pressure of a gasification chamber that is part of the non-combustive gasification system is achieved in the collection vessel. An assessment platform, which can include one or more sensor enables monitoring pressure in the collection vessel. Still another stage comprises delivery of at least a portion of the first amount of feedstock material to an accumulation chamber, which is coupled to at least one air-lock valve in the collection vessel. The accumulation chamber can include a cooling jacket, that mitigates excessive heating (e.g., heating to temperature above a predetermined temperature value) of the at least one air-lock valve. In addition, the accumulation chamber is coupled to a gasification chamber that performs at least part of a specific gasification process. In an aspect, a tapered cavity that is part of the accumulation chamber is coupled to a rotating drum that houses feedstock and resides within the gasification chamber. Moreover, the accumulation chamber includes an injector apparatus, which in certain embodiments is a piston or ram that forces or ejects a load of feedstock into the gasification chamber; the piston or ram can include structural features that enable self-cleaning operation or allow simplified cleaning at times operation and maintenance (O & M) of the accumulation chamber is performed.

Further yet, another stage includes recovery of atmospheric pressure in the collection vessel; such stage enables at least (i) reduction of unsafe operation conditions than can arise if pressurized collection vessel is open to atmosphere without prior pressure relief, and (ii) controlled removal of debris (e.g., portions of feedstock) entrained in one or more parts of the collection vessel. In one or more embodiments, a compressor supplies pressurized air, or other type of gas, to an air cannon functionally coupled to a valve that regulated flow of gas into the collection vessel.

One or more embodiments of the subject disclosure also provide a valve that can thermally isolates a valve operating in proximity of high-temperature (e.g., from about 1100 to about 1750 F) equipment. The valve is installed amongst the high-temperature equipment and the valve operating in proximity thereto. In an aspect, the valve is a gated valve that is not sealed, but rather the valve gating enables or disables passage of feedstock material; the valve allows continuous or nearly continuous circulation of fluid, which is utilized to extract heat from a flow of heat directed towards the valve operating in proximity of the high-temperature equipment.

Various advantages emerge from features or aspects of the one or more embodiments disclosed herein. In particular, though not exclusively, the disclosed one or more embodiments mitigate or eliminate undesired moisture in loaded feedstock material and, in a related aspect, substantially or strictly block fugitive steam which can cause caking of feedstock material.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example system for supplying feedstock material in a non-combustive gasification system in accordance with aspects of the subject disclosure.

FIG. 2 presents an example system that enables refrigeration of a valve functionally coupled to a feedstock collection vessel in accordance with aspects described herein.

FIG. 3 illustrates a cross-sectional view of an example embodiment of a thermal insulation valve (TIV) in accordance with aspects described herein.

FIG. 4 presents a flowchart of an example process for supplying feedstock material to a non-combustion gasification system according to aspects of the subject disclosure.

FIG. 5 is a flowchart of an example process for purging air from a collection chamber in a feedstock supply system in accordance with aspects described herein.

FIG. 6 is a flowchart of an example process for recovering atmospheric pressure in a collection vessel according to aspects described herein; the collection vessel can be part of the example feedstock supply system in FIG. 1.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the present disclosure. It may be evident, however, that the various embodiments of the subject disclosure may be practiced without these specific details. In other instances, well-known structures and devices are shown in block diagram form in order to facilitate describing the present disclosure.

As employed in this specification and annexed drawings, the terms “component,” “system,” “structure,” “platform,” “interface,” and the like are intended to include a computer-related entity or an entity related to an operational apparatus with one or more specific functionalities, wherein the entity can be either hardware, a combination of hardware and software, software, or software in execution. One or more of such entities are also referred to as “functional elements.” As an example, a component may be, but is not limited to being a process running on a processor, a processor, an object, an executable, a thread of execution, a program, and/or a computer. As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. An illustration of such a component can be a water pump. In addition or in the alternative, a component can provide specific functionality based on physical structure or specific arrangement of hardware elements; an illustration of such a component can be a filter or a fluid tank. As yet another example, a component can be an apparatus that provides specific functionality through electronic components without mechanical parts, the electronic components can include a processor therein to execute software or firmware that provides at least in part the functionality of the electronic components. An illustration of such apparatus can be control circuitry, such as a programmable logic controller. The foregoing example and related illustrations are but a few examples and are not intended to limiting. Moreover, while such illustrations are conveyed for a component, the examples also apply to a system, a structure, a platform, an interface, and the like.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of synthesis gas collection structures includes one or more synthesis gas collection structures; a set of devices includes one or more devices; a set of regulators includes one or more regulators; etc.

Various aspects or features will be presented in terms of systems that may include a number of devices, components, modules, and the like. It is to be understood and appreciated that the various systems may include additional devices, components, modules, etc., or may not include all of the devices, components, modules etc. discussed in connection with the figures. A combination of these approaches also can be used.

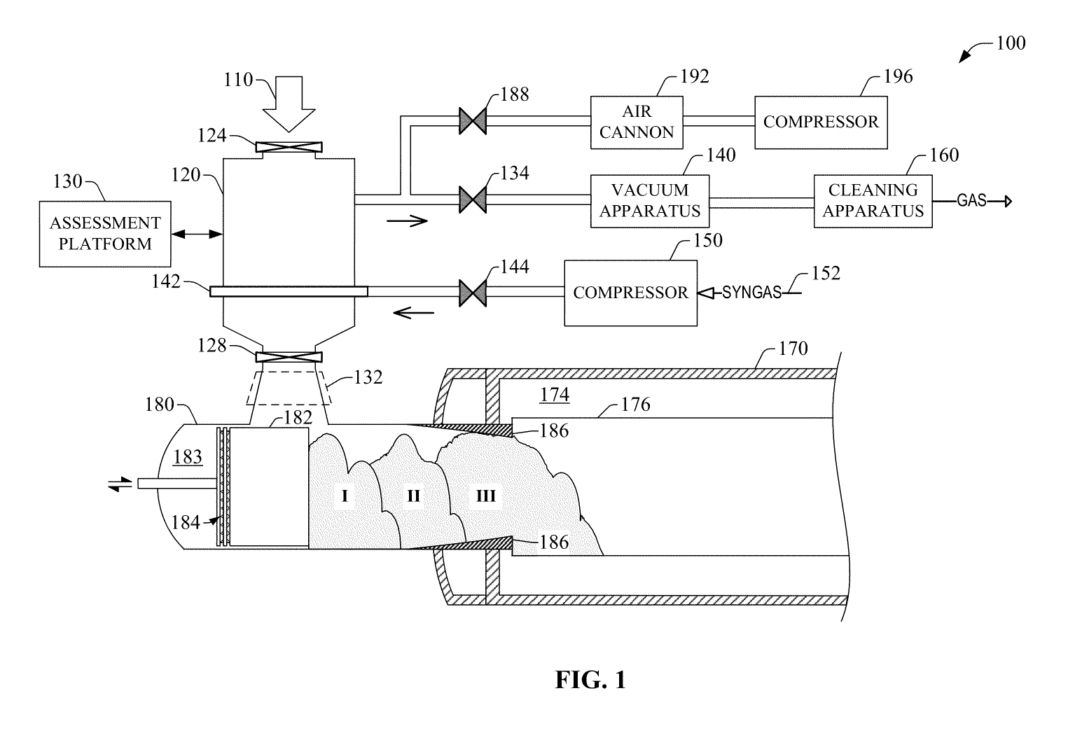

FIG. 1 illustrates an example feedstock supply system 100 in accordance with aspects of the subject disclosure. The example feedstock supply system 100 is part of a non-combustive gasification system and enables provision of feedstock material in batch mode—semi-continuous batch mode or continuous batch mode. In example feedstock supply system 100 feedstock material is received in a hopper (not shown) coupled to a collection vessel 120. The feedstock material can be received at least in part through a conveyor line (not shown) that delivers the feedstock material to the hopper (not shown); feedstock material can collect continually in the hopper (not shown). Feedstock material generally is received from a distributor and can include various types of solids, such as biomass (wood, rice, corn, or sugar cane harvest waste, etc.), municipal waste (moist or dry), farm compost, coal, petroleum coke, and the like.

A valve 124 in the collection vessel 120 is open and an amount of feedstock material 110 is injected into the collection vessel 120; valve 128 at the opposing end of collection vessel 120 is closed. The amount of feedstock material 110 can be metered based on capacity of the collection vessel 120. In an aspect, valve 124 (also referred to as feed valve 124) is opened for a specific period suitable to load collection vessel 120 with a predetermined volume or mass that renders the collection vessel full or nearly full. In addition or in the alternative, the amount of feedstock material can be metered, at least in part, through an assessment platform 130 that monitors a level to which the collection vessel 120 is filled and closes valve 124 if the collection vessel is filled to a predetermined level. Injection of the amount of feedstock material 110 based at least on a feedback loop implemented by assessment platform 130 increases operational and structural complexity of example feedstock supply system 100; however, implementation of the feedback loop to regulate the injection of the amount of feedstock material 110 increases versatility of example feedback supply system 100, enabling it to operate with various feedstock materials of different types (e.g., different densities).

After the amount of feedstock material 110 has been injected into the collection vessel 120, valve 124 is closed and valve 134 is open. Opening of valve 134 allows vacuum apparatus 140 to produce vacuum in collection vessel 120. Valve 134 remains open for a period suitable to reduce pressure in collection vessel 120 to a satisfactory level and then (e.g., upon reaching the satisfactory level or thereafter) valve 144 is opened. At least one predetermined, configurable criterion, such as a threshold value, can dictate what a satisfactory pressure is. Assessment platform 130 can enable monitoring pressure (or vacuum level for pressure below atmospheric pressure) in the collection vessel 120. In an illustrative scenario, the suitable period can range from about 2 seconds to about 3 seconds, depending at least on the vacuum apparatus (e.g., mechanic vacuum pump, turbomolecular pump), feedstock material type, and operational integrity (e.g., absence of leaks) of collection vessel 120.

In example feedstock supply system 100, producing the vacuum allows atmosphere (air or other atmospheric gases) introduced with the amount of feedstock material 110 to be evacuated to reduce, minimize, or avoid injection of oxygen into the non-combustive gasification system. In addition, injection of dry syngas into collection vessel 120 while valve 134 is open and vacuum apparatus 140 evacuates gas (air, syngas, or a combination thereof) from the collection vessel 120 enables As described supra, at least in part, to flush or displace air and other atmospheric gases that can be present in collection vessel 120. Removal of air mitigates (e.g., avoids) injection of air into a gasification chamber 170 in which at least part (e.g., one phase) of a non-combustive gasification process is performed. In an aspect, the combination of the evacuation of gas in collection vessel 120 and circulation (e.g., injection and evacuation) of syngas through collection vessel 120 can result in oxygen levels below about 300 parts per million (ppm) within an environment in which supplied feedstock material is gasified. Low levels of oxygen can improve substantially the quality (H₂/CO ratio, concentration of impurities, etc.) of synthesis gas produced as part of the non-combustive gasification process.

Gas evacuated from collection vessel 120 is circulated through a cleaning apparatus 160 that removes of any or most any feedstock particulate matter entrained in the gas. The cleansed gas is supplied delivered into a closed circuit (not shown) of combustion air to capture any British thermal unit (BTU) value that may be present in such gas and thus improve energy balance of the non-combustive gasification process that gasifies feedstock material in accordance with aspects described herein. At least one advantage of the closed circuit (not shown) for combustion air is that process gas resulting from non-combustive gasification process is not released to the atmosphere with the ensuing environmental adequacy. Thus administrative procedures such as procurement of permit(s) for deployment of non-combustive gasification systems described herein can be simplified.

It should be appreciated that removal of feedstock particulate matter reduces or avoids clogging of burners that operate as sources heat for the non-combustive gasification process. It is noted that cleaning apparatus 160 does not operate properly if wet by moisture originated from steam. In one or more embodiments, the cleaning apparatus is a baghouse; however, most any cleaning apparatus (dry scrubber, wet scrubber, cyclone, etc.) can be employed.

After a suitable time interval during which collection vessel 120 is purged—evacuated via vacuum apparatus 140 and supplied with syngas 152 through compressor 150—valve 134 is closed while valve 144 is maintained open. It is noted that in certain conventional gasification systems flue gas is circulated through feedstock in a pressure vessel, such vessel is not purged as described herein, but rather the feedstock is dried and atmosphere introduced with the feedstock is removed gravimetrically. As it is readily apparent, removal of atmosphere in such manner introduces design and deployment complexities. Such complexities are absent in example system 100. In certain embodiments, the suitable time can be a predetermined, configurable time. In alternative or additional embodiments, the suitable time can be at least the time that is elapsed prior to achieving a predetermined vacuum level (or pressure level below atmospheric pressure) in the collection vessel 120. Since valve 134 (also referred to as actuated valve 134) is closed and valve 144 (also referred to as actuated valve 144) is open, syngas 152 is injected into collection vessel 120 and pressurizes it; syngas 152 can be delivered as a result of positive pressure at which the syngas 152 is produced in the non-combustive gasification system that includes collection vessel 120. After pressure in collection vessel 120 reaches substantially the pressure of syngas 152, compressor 150 can be started to increase pressure in collection vessel 120. It is noted that in certain embodiments, syngas 152 can be conveyed to compressor 150 at a pressure that is lower (e.g., at least about 4 psi lower) than plant pressure or pressure in gasification chamber 170; various equipment (flow meter(s), scrubber(s), etc.) can cause pressure of syngas 152 to be lower than plant pressure. In an aspect, compressor 150 pressurizes collection vessel 120 to a pressure greater than the operating pressure gasification chamber 170; in one or more embodiments, operating pressure ranges from about 25 psi to about 100 psi. In another aspect, compressor 150 is employed to pressurize collection vessel 120 because of drops in pressure over the system; magnitude of the drop in pressure can range from about 1 psi to about 5 psi. A gas plenum assembly 142 allows injection of synthesis gas into collection vessel 120.

Assessment platform 130 can monitor pressure of collection vessel 120 and close valve 144 if the pressure in the collection vessel 120 is above a predetermined value. After such pressurization of collection vessel 120, valve 128 is opened. Opening of valve 128 (also referred to as feed valve 128) allows at least a portion of the amount of feedstock material 110 contained in collection vessel 120 to be supplied to accumulation chamber 180 at at least the operating pressure (e.g., a pressure in the range from about 25 psi to nearly 100 psi) of gasification chamber 170. The amount of feedstock material that is loaded in accumulation chamber 180 is dictated at least in part by a feed rate, e.g., a rate at which the amount of feedstock material 110 is supplied.

Accumulation chamber 180 serves as a pre-heat and filtration zone for feedstock material. In certain embodiments, a top portion of the accumulation chamber 180 can be surrounded by a cooling jacket 132; such portion directly attaches, or couples, to valve 128. In an aspect, the cooling jacket reduces heat flow from the gasification chamber 170 towards valve 128, thus increasing reliability and durability of at least valve 128. Inclusion or exclusion of the cooling jacket 132 can be determined based in part on energy balance of the non-combustive gasification conducted, in part, in gasification chamber 170; for instance, such energy balance with indicate that a significant amount of heat can flow towards valve 128 and thus the cooling jacket 132 is needed. In addition, accumulation chamber 180 includes an injection structure, such as an auger or a plunger, that enables forcing feedstock material collected in the accumulation chamber 180 into the gasification chamber 170 (e.g., a pyrolysis chamber). In one or more embodiments, the injection structure can be embodied in a pneumatic cylinder functionally coupled (e.g., through a rigid bar and suitable attachment(s)) to a plate that can push feedstock material into gasification chamber 170. Direction of motion of of piston 182 is represented with half-head arrows in FIG. 1. In the illustrated embodiment, the injection structure is a piston 182 that forces feedstock material (represented with three loads or amounts I, II, and III) into gasification chamber 170. Piston 182 has two rings, or grooves, 184 (represented with cross-hatched blocks) to wipe the piston cylinder clean, and prevent feedstock material from collecting in cavity 183. It should be appreciated that in certain embodiments, cavity 183 can be cleaned according to schedule maintenance to ensure adequate operation. In an aspect, such rings 184 do not advance farther than the fully surrounded portion of accumulation chamber 180. It should be appreciated that the number of rings in piston 182 is a design choice and more or less rings can be cast in piston 182. Alternative or additional structures other than rings also can be exploited to wipe clean the piston 182.

In the illustrated embodiment, accumulation chamber 180 is tapered; represented by right-slanted zones. Structures 186 render the accumulation chamber 180 tapered and enable compressing the feedstock material as it is advanced to gasification chamber 170 (e.g., pyrolysis chamber). Structures 186 can be solid wedges affixed (welded, bolted, screwed, etc.) to the interior on accumulation chamber 180 or can include elastic slabs (e.g., loaded springs) that provide a variable tapered section based at least on amount (e.g., volume or mass) of loaded feedstock (e.g., loads I-III). In the subject disclosure, compression of the feedstock material can limit the amount of steam backward-fed to collection vessel 120. Mitigation or eradication of fugitive steam, or backward flowing steam, reduces amount of steam that can reach cleaning apparatus 160 and thus operation integrity (e.g., filtration capacity) thereof is preserved. In addition, since gasification chamber 170 operates at elevated temperatures (e.g., from about 1100° F. to about 1700° F.), injection of feedstock material through compression of feedstock load (e.g., loads I, II, III) via piston 182 also allows the feedstock to be preheated prior to entering housing 176.

It should be appreciated that certain conventional systems exploit compression of certain feedstock (coal) to high pressures (e.g., from 10-20 psi) and tapered pipes for injection into a chamber for combustive gasification; yet, in such conventional systems, issues associated with fugitive steam are absent. Moreover, such conventional systems lack various of the features described herein; particularly, though not exclusively, the different stages of feedstock injection described herein.

The feedstock material (illustrated with shaded areas representing three loads of feedstock) is injected into a housing structure 176 (e.g., a metal drum). The housing structure 176 occupies a cavity 174, wherein the cavity has a size defined primarily by the size of the gasification chamber 170. The housing structure can be static or can rotate about an axis; rotation can increase heat transfer amongst the feedstock material that is injected into the housing structure 176 and thus increase efficiency of the non-combustion gasification phase. In additional or alternative embodiments, gasification chamber 170 does not include housing structure 176.

After the amount of feedstock material 110 is supplied (e.g., released and driven by gravitational force) to accumulation chamber 180, valve 128 is closed and a stage to recover atmospheric pressure in collection vessel 120 is implemented. Recovery of atmospheric pressure in collection vessel 120 enables another amount of feedstock material to be collected in the collection vessel 120. Valve 134 is opened to exhaust pressure contained in collection vessel 120 and return it to atmospheric pressure so that collection vessel 120 can be opened without creation of a violent release of gas, e.g., syngas, and the pressure associated with the gas. Normal atmospheric condition is recovered from operating pressure, e.g., nearly 25 psi to nearly 100 psi. Gas, e.g., syngas, released in response to opening valve 134 is passed through cleaning apparatus 160 and supplied as combustion air for the reasons described supra.

After or at the time atmospheric pressure is recovered in collection vessel 120, valve 134 is closed; assessment platform 130, or one or more components therein, can measure pressure level in collection vessel 120 and transmit a signal when the pressure is atmospheric pressure or substantially atmospheric pressure. In addition, valve 124 and valve 188 is open. In the illustrated embodiment, valve 188 (also referred to as actuated valve 188) is functionally coupled to at least collection vessel 120, air cannon 192 and compressor 196. Opening valve 188 allows air cannon to blast a volume of air to clean a purge screen that can be part of collection vessel 120. In an embodiment, valve 188 can be maintained open from about 1 second to about 2 seconds to blast the volume of air. In certain embodiments, valve 144 can be partially open while the volume of air is blasted into collection vessel 120.

After atmospheric pressure in collection vessel 120 is recovered a feed batch cycle comprising numerous iterations of the cycle of feedstock injection, purging, and feedstock transfer described supra can continue. The feed batch cycle can have a predetermined batch cycle period, which can range from about 1 minute to about 10 minutes. It should be appreciated that the feed batch cycle can be implemented continuously or nearly continuously. Example feedstock supply system 100 can provide feedstock material at a feed rate that ranges from about 5 to about 500 dtpd (dry tons per day).

In example feedstock supply system 100, assessment platform 130 autonomously or automatically assesses if operational conditions (load level, vessel pressure, partial pressure of oxygen, partial pressure of syngas, etc.) in collection vessel 120 warrant at least one valve to be open or closed. To conduct an assessment, assessment platform 130 can include a set of sensors, or other equipment, that measure, or gather data, related to the operational conditions of collection vessel 120. Assessment platform 130 can exploit control logic (e.g., computer-executable code instructions) that regulates the feeding batch cycle enabled by example feedstock supply system 100. In an aspect, the control logic dictates instants at which valves 124, 128, 134, 144, 188 open or close. In another aspect, the control logic establishes a set of criteria (not shown) that allows determination of acceptable or suitable operational conditions of at least collection vessel 120; the set of criteria can be stored in a memory or memory element (database, register, file(s), etc.) within assessment platform 130 or functionally coupled thereto.

Assessment platform 130 can be part of equipment, components, or other structure for automated control of the various portions of the feeding batch cycle described herein and related gasification process. The equipment, components, or other structure for automated control can be deployed and configured (e.g., programmed) in accordance with various aspects described herein and via conventional and novel control paradigms, mechanisms, or programming. The equipment, components, or other structure for automated control are not shown.

In one or more embodiments, assessment platform 130 can exploit artificial intelligence (AI) methods to generate the foregoing assessment(s) without human intervention as described supra. Such intelligence can be generated through inference, e.g., reasoning and conclusion synthesis based upon a set of metrics, arguments, or known outcomes in controlled scenarios, or training sets of data. Artificial intelligence methods or techniques referred to herein typically apply advanced mathematical algorithms—e.g., decision trees, neural networks, regression analysis, principal component analysis (PCA) for feature and pattern extraction, cluster analysis, genetic algorithm, or reinforced learning—to a data set.

Such methodologies can include, for example, Hidden Markov Models (HMMs) and related prototypical dependency models can be employed. General probabilistic graphical models, such as Dempster-Shafer networks and Bayesian networks like those created by structure search using a Bayesian model score or approximation can also be utilized. In addition, linear classifiers, such as support vector machines (SVMs), non-linear classifiers such as methods referred to as “neural network” methodologies, fuzzy logic methodologies can also be employed. Moreover, game theoretic models and other approaches that perform data fusion, etc., can be exploited.

Processor(s) (not shown) can be configured to provide or can provide, at least in part, the described functionality of an assessment platform, or components therein, that can determine whether quality of produced synthesis gas in a secondary gasification phase (e.g., 130) warrants bypassing a steam reformation phase, or spectral properties of disposable solid(s) indicated that further gasification can be achieved through implementation of an additional cycle of the secondary gasification phase.

In an aspect, to provide such functionality, the processor(s) can exploit a bus that can be part of the assessment platform to exchange data or any other information amongst components therein and a memory (not shown) or elements therein, such as or algorithm store, data store, or monitoring logic, etc. The bus can be embodied in at least one of a memory bus, a system bus, an address bus, a message bus, or any other conduit, protocol, or mechanism for data or information exchange among components that execute a process or are part of execution of a process. The exchanged information can include at least one of code instructions, code structure(s), data structures, or the like.

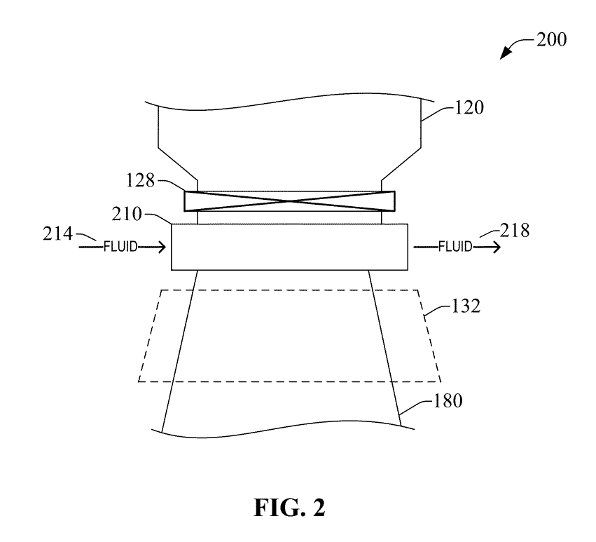

In an aspect of the subject disclosure, in feedstock injection systems, such as example system 100, as the diameter of feed valve(s) increases, utilization of cooling jackets (e.g., 132) surrounding the exterior of pipes or conduits attached to the feed valve(s) to thermally isolate the feed valve(s) from high-temperature equipment (e.g., accumulation chamber 180) becomes largely inefficient. Inefficiency in extraction of heat from the heat flow from high-temperature equipment to the feed valve(s) is the result of reduced surface area to volume ratio for larger pipes and conduits attaching with the feed valve(s). As an example, a water jacketed pipe with a diameter of about 36 inches and with a flow of 1000° F. gas passing through it would not extract an effective amount of heat from the center of the entrained flow of gas. FIG. 2 presents a block diagram of an example system 200 that enables refrigeration of a valve functionally coupled to a collection vessel for feedstock collection in accordance with aspects described herein. In an aspect, the collection vessel is collection vessel 120.

Example system 200 includes cooling jacket 132; as described supra, inclusion of cooling jacket 132 is optional. In addition, example system 200 includes a thermal insulation valve 210 (TIV 210) that is functionally coupled (e.g., removably attached or fixedly attached) to valve 128 and provides thermal insulation, or thermal isolation, to at least collection vessel 120 when valve 128 is closed. TIV 210 can exploit a fluid (water, air, liquid coolant, etc.) as cooling medium; TIV 210 can be manufactured of any material with a thermal conductivity suitable for efficient heat exchange amongst the cooling medium and valve 128 and surrounding portions of collection vessel 120 and accumulation chamber 180. In an aspect, TIV 210 can operate as a gate valve, synchronized or substantially synchronized with valve 128; a gating mechanism (not shown in FIG. 2) can be controlled by assessment platform 130 or a disparate controller apparatus or control platform. Gating operation of thermal insulation valve 210 is directed to allowing or disallowing passage of an amount of feedstock material from collection vessel 210 to accumulation chamber 180 (partially shown in FIG. 2). Fluid circulates continuously or substantially continuous through refrigeration valve 210: A first volume of fluid (e.g., fluid 214) is injected into the refrigeration valve and a first temperature and a second volume of fluid (e.g., 218) is ejected at a second temperature. It should be appreciated that the first volume of fluid is generally substantially the same as the second volume, while the second temperature is commonly higher than the first temperature as a result of heat extraction from accumulation chamber 180. While cooling jacket 132 is optional, in common operation scenarios, TIV 210 is installed in conjunction with cooling jacket 132 to increase thermal insulation of valve 128 and accumulation chamber 180.

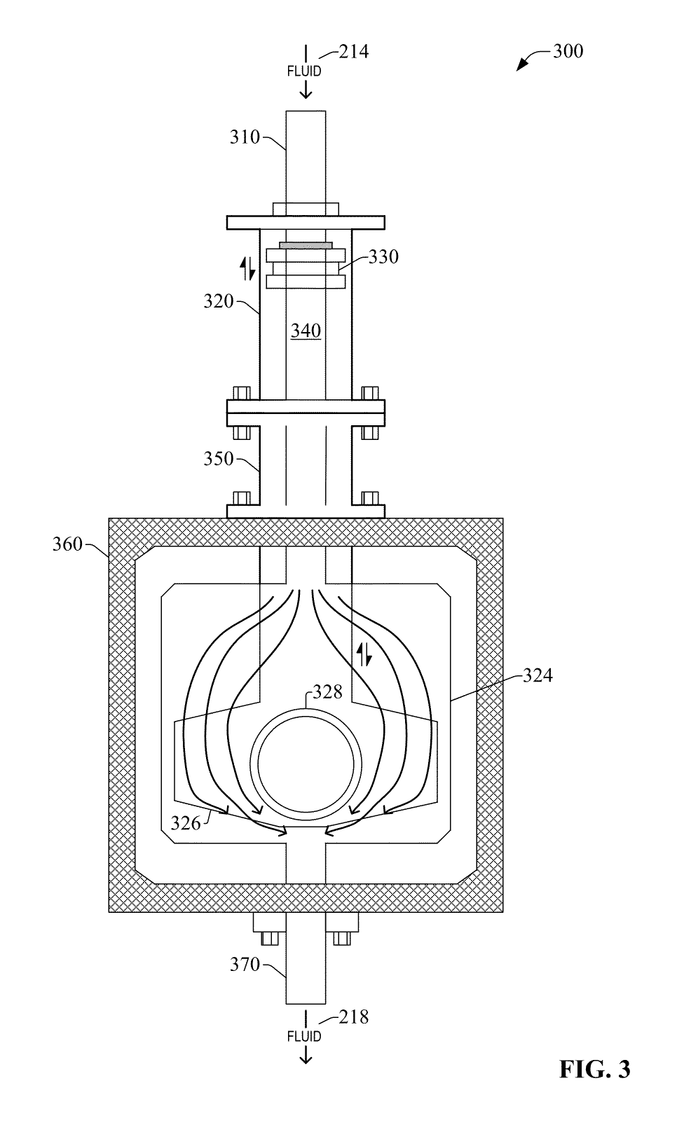

FIG. 3 illustrates a cross-sectional view of an example embodiment 300 of TIV 210 in accordance with aspects described herein. An inlet 310 collects fluid 214 and is attached (removably or fixedly) to a first flange in a hydraulic cylinder 320. A hydraulic piston 330 can slide within shaft 340 and enable opening and closing of TIV 210. In an aspect, a movable knife, or flange, 326 can block aperture 328, thus closing the TIV 210. In certain embodiments, movable knife 326 can be hollow to allow circulation of fluid (represented in FIG. 3 as curved, thick lines with an arrow head indicating flow direction). In other embodiments, movable knife 326 can include a serpentine, or other conduit structure, to enable circulation of fluid. Movable knife, or flange, 326 can be manufactured in accordance with various industry standards (ANSI, ISO, etc.). Motion of hydraulic piston 330 can be transferred to movable knife 326 through suitable structure (pipe, bar, etc.). Half-head arrows indicate movable knife 326 can move to block appearture 328. The hydraulic piston 330 allows passage of fluid 214 through shaft 340. Circulation of fluid 214 via the shaft 340 refrigerates hydraulic cylinder 320 and hydraulic piston 330. Such refrigeration enables operation of such hydraulic cylinder 320 in proximity to high-temperature (e.g., about 1100° F. to about 1750° F.) equipment. Refrigeration of the hydraulic cylinder 320 and hydraulic piston 330 maintains operating temperatures in a range that provides operational integrity, and thus mitigates or avoids complication(s) related to high-temperature operation of hydraulic component(s) or mechanism(s) that enable movement of hydraulic piston 330. In FIG. 3, half-head arrows indicate hydraulic piston 330 is movable along the axis of shaft 340. Operation in proximity of high-temperature equipment is at least one advantage of TIV 210 over conventional gate valves that exploit hydraulics mechanism(s) to open or close.

Hydraulic cylinder 320 is functionally coupled to valve housing 360 in TIV 210 via a connector 350; the connector 350 can be a cylinder mount, a packing gland, or any suitable mechanical piece that provides stably couples the hydraulic cylinder 320 to valve housing 360. Gasket(s), bolts, or other connecting elements enable, in part, coupling of hydraulic cylinder 320 to valve housing 360. In an aspect, for an example connector 350 that has a circular section, diameter of such example connector 350 can range from about 6 inches to about 48 inches. It should be noted that other sizes of connector 350 also can be employed. Size of valve housing 360 and moving knife 326 is dictated by at least one or more of cross-sectional size of valve 128, cross-sectional size of the neck portion of accumulation chamber 180 (see, e.g., FIG. 2), or volume of fluid circulating through the TIV 210. As an illustration, for a flow of 20 gallons of water per minute, the typical size of valve housing 360 is at least about 360.

The valve housing 360 seals and holds pressure on the top and bottom (feedstock inlet and feedstock outlet) pipe flanges that couple, respectively, TIV 210 to valve 128 and TIV 210 to accumulation chamber 180. The valve housing 360 also seals or holds pressure in connector 250 (e.g., a packing gland) and outlet 370; generally, valve housing 360 seal any connectors coupling the protruding shafts at the ends of valve housing 360. Accordingly, TIV 210 is a sealed valve that (a) can maintain plant pressure, without or substantially without issues associated with leaking packing seals that seal gate enclosure 324.

When opened, TIV 210 allows an amount of feedstock to pass through aperture 328, wherein the area of aperture 328 is determined by the size (e.g., diameter) of the neck portion of accumulation chamber 180 (not shown in FIG. 3); whereas when closed, TIV 210 blocks passage of feedstock through aperture 328 and circulation of fluid through moving knife 326 extracts heat flowing from accumulation chamber 180 (not shown) towards valve 128; thus, TIV 210 thermally insulates, at least in part, valve 128 from at least at least a portion of accumulation chamber 180.

As described supra, collection vessel 120 can be purged with syngas. Since syngas is a hydrogen rich gas and the auto-ignition temperature of hydrogen is about 930° F., at least one advantage of TIV 210 is prevention of auto-ignition of syngas utilized to purge collection vessel 120. It should be appreciated that TIV 210 can be employed in any or most any system(s), and related process(es), in which thermally protecting at least one valve or other equipment can be advantageous (e.g., ensure equipment integrity or personnel safety).

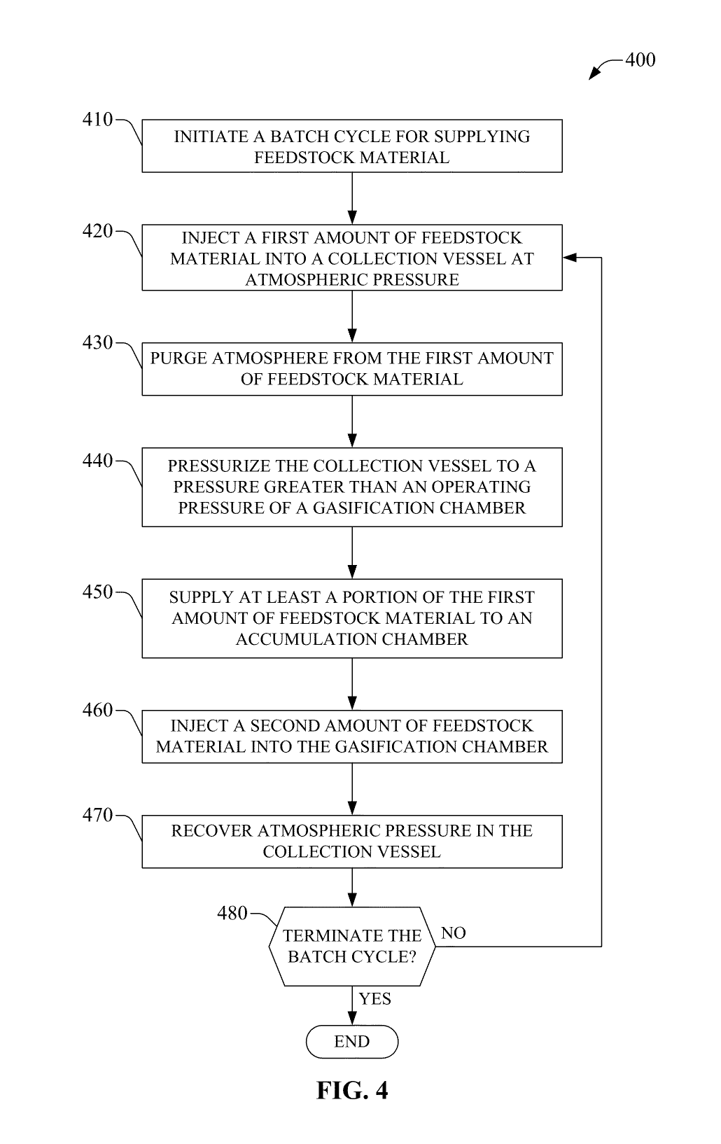

In view of the example system(s) described above, example process(es) that can be implemented in accordance with the disclosed subject matter can be better appreciated with reference to flowcharts in FIGS. 4-6. For purposes of simplicity of explanation, example processes disclosed herein are presented and described as a series of acts; however, it is to be understood and appreciated that the disclosed subject matter is not limited by the order of acts, as some acts may occur in different orders and/or concurrently with other acts from that shown and described herein. For example, one or more example processes disclosed herein can alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example process in accordance with the subject disclosure. Further yet, two or more of the disclosed example processes can be implemented in combination with each other, to accomplish one or more features or advantages described herein.

FIG. 4 presents a flowchart of an example process for supplying feedstock material to a non-combustion gasification system according to aspects of the subject disclosure. The subject example process embodies a batch cycle that can be in semi-continuous mode or in continuous mode. The batch cycle can be configured in numerous manners; for instance, a configuration can establish a batch cycle with a high interval operation (e.g., a short batch time span, such as from about 1 min to about 10 min). One or more components or structures in example feedstock supply system 100 enable implementation of the subject example method; accordingly, various acts of example process 400 are illustrated with reference to example feedstock supply system 100. At act 410, a batch cycle can for supplying the feedstock material is initiated. Initiating the batch includes recovering atmospheric pressure in one or more chambers of the feedstock supply system that implement that subject example process, or resetting (e.g., closing) a set of valves in such feedstock supply system.

At act 420, a first amount of feedstock material (e.g., 110) is injected into a collection vessel (e.g., 120) at atmospheric pressure. The injecting includes opening a first valve (e.g., valve 124) in the collection vessel to allow the feedstock material to enter the collection vessel; the first valve is opened for a finite time interval and then is shut. As described supra, the amount of feedstock material can be metered based on capacity of the collection vessel. In an aspect, as described supra, the injecting can include monitoring the level to which the collection vessel is occupied and closing the first valve in response to achieving an intended level of feedstock in the collection vessel.

At act 430, atmosphere is purged from the first amount of feedstock material. As described supra, purging the air includes evacuating the collection chamber and injecting dry syngas into the collection chamber. At act 440, the collection vessel is pressurized to a pressure greater than an operating pressure of a gasification chamber (e.g., 140). At act 450, at least a portion of the first amount of feedstock material is supplied to an accumulation chamber (e.g., 180). In an aspect the supplying is accomplished passively (e.g., without utilization of a dedicated device or apparatus) and it includes opening a second valve (e.g., valve 128) in the collection chamber and allowing the gravitational field to provide the motive force to supply the first amount of feedstock material.

At act 460, a second amount of feedstock material is injected into the gasification chamber (e.g., 170). In an aspect, the second amount of feedstock material is substantially the same as the first amount of feedstock material. Some small portions of the first amount of feedstock material can be evacuated at act At act 470, atmospheric pressure in the collection chamber is recovered. At act 480, it is determined if the batch cycle is to be terminated. An affirmative determination results in the subject example process to end, whereas a negative determination directs the flow to act 420.

Acts 420 through 470 form a loading batch iteration, wherein the batch cycle can include one or more loading batches. As described supra and elaborated hereinafter, the loading batch iteration includes various synchronized, or ordered (in time domain), opening and closing of various valves that enable various acts that are part of the loading batch.

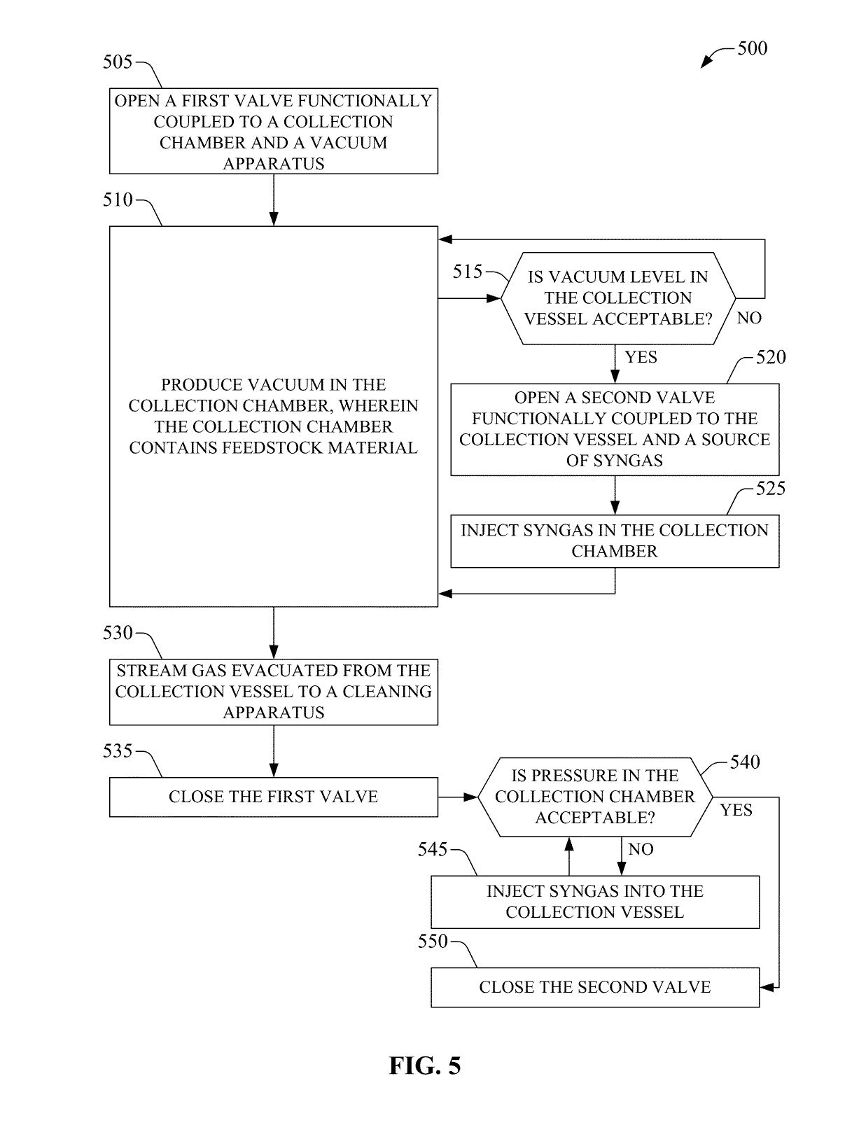

FIG. 5 is a flowchart of an example process 500 for purging air from a collection chamber in a feedstock supply system in accordance with aspects described herein. The subject example process can embody act 430. At act 505, a first valve (e.g., valve 134) is open; the first valve is functionally coupled (e.g., linked in a manner that enables exchange of material(s)) to at least a collection chamber (e.g., 120) and a vacuum apparatus (e.g., 140). At act 510, vacuum is produced in the collection chamber, wherein the collection chamber contains feedstock material. At act 515, it is determined if vacuum level in the collection chamber is acceptable. At least one predetermined, configurable threshold can dictate what an acceptable vacuum level is. As described supra, assessment platform 130 can enable monitoring vacuum level in the collection chamber. In case the vacuum level is not acceptable, flow is directed to act 510. It should be appreciated that acts 510 and 515 can be enacted simultaneously.

In case such vacuum level is acceptable, at act 520, a second valve (e.g., valve 144) is open, wherein the second valve is functionally coupled to at least the collection chamber (e.g., 120) and a source of syngas. At act 525, syngas is injected into the collection chamber. In an aspect, the syngas is injected into the collection chamber while the vacuum in the collection chamber is produced. As described supra, injecting the syngas enables, at least in part, to displace air and other atmospheric gases that can be present in the collection chamber that is evacuated due to producing the vacuum. At act 530, gas evacuated from the collection chamber is stream to a cleaning apparatus. The gas includes particulate matter, air, syngas, or a combination thereof: Prior to opening the second valve, the gas is primarily air and particulate matter; subsequent to opening the second valve and injecting syngas, the gas includes an amount of air, syngas, and particulate matter. At act 535, the first valve (e.g., valve 134) is closed.

At act 540, it is determined if pressure in the collection chamber is acceptable; as indicated supra, acceptability can be dictated by predetermined criteria (e.g., set of thresholds). In case the pressure is not acceptable, at act 545, syngas is injected into the collection chamber; it should be appreciated that act 545 is substantially the same or the same as act 525. In case pressure is acceptable, the second valve (e.g., valve 144) is closed at act 550.

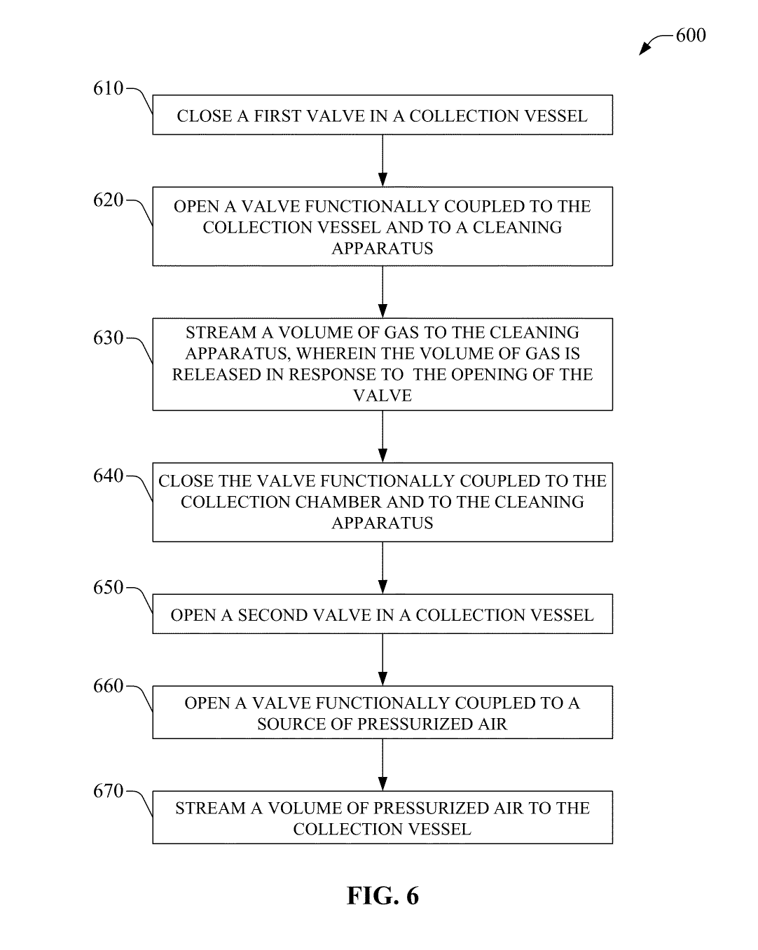

FIG. 6 is a flowchart of an example process 600 for recovering atmospheric pressure in a collection vessel according to aspects described herein; the collection vessel can be part of a feedstock supply system described in the subject disclosure. At act 610, a first valve (e.g., valve 128) in a collection vessel is closed. At act 620, a valve functionally coupled to at least the collection vessel and a cleaning apparatus is opened. At act 630, a volume of gas is streamed to the cleaning apparatus, wherein the volume of gas is released in response to the opening of the valve. At act 640, the valve functionally coupled to at least the collection vessel and the cleaning apparatus is closed. At act 650, a second valve (e.g., valve 124) in the collection vessel is opened. At act 660, a valve functionally coupled to a source of pressurized air is opened. At act 670, a volume of pressurized air is streamed (e.g., blasted) to the collection vessel.

Based on the various aspects of features described herein, several advantages of the subject system, and related process(es) emerge. The disclosed feedstock supply system(s) and process(es) that reduce atmosphere, e.g., air or other atmospheric gases, that are present in feedstock material; reduction of atmosphere in the feedstock material reduces the likelihood of production of nitrogen oxides (NOx) and oxygen (atomic and molecular) in gas (synthesis gas, pyrolysis gas, etc.) produced through non-combustive gasification of the feedstock material. In addition, the disclosed system(s) and process(es) mitigate or completely avoid backward flow of steam originated at least in part from moisture present the supplied feedstock—such steam generally is low-temperature (e.g., several times lower than gasification temperature(s)) and it arises from injection of moist feedstock material into elevated-pressure, elevate-temperature environment in which non-combustive gasification process is conducted. Thus, the system(s) and process(es) mitigate or eliminate clogging problems associated such backward flow of steam (also referred to as fugitive steam) and related caking of feedstock material. In a related aspect, the disclosed feedstock supply system(s) and process(es) reduce caking of feedstock that can arise from such moisture. Moreover, the disclosed feedstock supply system(s) and process(es) mitigate operational problems related to circulating feedstock through an airlock apparatus while simultaneously preventing atmosphere from entering the non-combustive gasification system.

As employed in the subject disclosure, the term “relative to” means that a value A established relative to a value B signifies that A is a function of the value B. The functional relationship between A and B can be established mathematically or by reference to a theoretical or empirical relationship. As used herein, coupled means directly or indirectly connected in series by wires, traces or other connecting elements. Coupled elements may receive signals from each other.

In the subject disclosure, terms such as “store,” “data store,” data storage,” and substantially any term(s) that convey other information storage component(s) relevant to operation and functionality of a functional element (e.g., a platform) or component described herein, refer to “memory components,” or entities embodied in a “memory” or components comprising the memory. The memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of further illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Certain illustrative components or associated sub-components, logical blocks, modules, and circuits, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, certain steps or actions (or acts) of a process, method, or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, in some aspects, certain steps or acts of a process, method, or algorithm may reside as one or any combination or set of codes or instructions on a machine readable medium or computer readable medium, which may be incorporated into a computer program product.

While the foregoing disclosure discusses illustrative aspects and/or embodiments, it should be noted that various changes and modifications could be made herein without departing from the scope of the described aspects and/or embodiments as defined by the appended claims. In addition, although elements of the described aspects and/or embodiments may be described or claimed in the singular, the plural is contemplated unless limitation to the singular is explicitly stated. Moreover, all or a portion of any aspect and/or embodiment may be utilized with all or a portion of any other aspect and/or embodiment, unless stated otherwise. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A process, comprising:
(a) injecting a first amount of feedstock material into a collection vessel at atmospheric pressure;
(b) purging atmosphere from the first amount of feedstock material in the collection vessel, wherein the purging includes:
evacuating the collection vessel; and
if a first pressure level in the collection vessel is below a first predetermined value, injecting synthesis gas generated in a non-combustive gasification system comprising the collection vessel;
(c) pressurizing the collection vessel to a reference pressure greater than operating pressure of a gasification chamber that is part of the non-combustive gasification system;
(d) supplying at least a portion of the first amount of feedstock material to an accumulation chamber;
(e) injecting a second amount of feedstock material into the gasification chamber; and
(f) recovering atmospheric pressure in the collection vessel.

2. The process of claim 1, further comprising:
reiterating acts (a) through (f).

3. The process of claim 1, wherein the purging further includes:
streaming gas evacuated from the collection vessel to a cleaning apparatus, wherein the gas comprises one or more of a volume of air or a volume of synthesis gas.

4. The process of claim 3, further comprising:
collecting clean gas in a closed circuit of combustion air.

5. The process of claim 1, wherein the pressurizing includes:
terminating the evacuating; and
injecting synthesis gas into the collection chamber if a second pressure level in the collection vessel is below about the reference pressure.

6. The process of claim 5, wherein the pressurizing further includes:
shutting injection of the synthesis gas into the collection chamber if the second pressure level is above or nearly equal to the second predetermined value.

7. The process of claim 1, wherein the recovering includes:
opening a valve functionally coupled to the collection vessel and to a cleaning apparatus;
streaming a volume of gas to the cleaning apparatus, wherein the volume of gas is released in response to the opening of the valve; and
closing the valve functionally coupled to the collection chamber and to the cleaning apparatus.

8. The process of claim 7, wherein the recovery further includes:
opening valve in the collection vessel;

9. The process of claim 7, wherein the recovery further includes:
opening a valve functionally coupled to a source of pressurized air; and
streaming a volume of pressurized air from the source of pressurized air to the collection vessel.

10. The process of claim 9, wherein the streaming includes:
blasting the volume of pressurized air through at least an air cannon.

11. The process of claim 1, wherein injecting a second amount of feedstock material into the gasification chamber includes:
forcing a load of feedstock material through a tapered cavity in the accumulation chamber, wherein the load of feedstock material includes the first amount of feedstock material.

12. A system, comprising:
a collection vessel that receives a first amount of feedstock material;
a vacuum apparatus that evacuates the collection vessel;
a first injector apparatus that supplies synthesis gas to the collection vessel if a first pressure level in the collection vessel is below a first predetermined value or above an operating pressure of a non-combustive gasification system, wherein the non-combustive gasification system generates the synthesis gas and comprises the collection vessel; and
a structure that enables recovery of atmospheric pressure in the collection vessel.

13. The system of claim 12, wherein the vacuum apparatus delivers gas evacuated from the collection vessel to a cleaning apparatus.

14. The system of claim 13, wherein the cleaning apparatus removes particulate matter from the gas and supplies the clean gas to a closed circuit of combustion air, wherein the closed circuit of combustion air is part of the non-combustive gasification system.

15. The system of claim 12, further comprising:
an accumulation chamber that receives at least a portion of the first amount of feedstock material, the accumulation chamber includes a tapered cavity coupled to a rotating drum within a gasification chamber in the non-combustive gasification system.

16. The system of claim 15, wherein the accumulation chamber includes a second injector apparatus that forces a load of feedstock material into the rotating drum in the gasification chamber, wherein the load of feedstock material comprises at least the portion of the first amount of feedstock material.

17. The system of claim 15, wherein the accumulation chamber includes a cooling jacket that mitigates heating of a valve in the collection vessel.

18. The system of claim 17, wherein the system includes a valve that thermally isolates, at least in part, the accumulation chamber and the collection vessel.

19. The system of claim 18, wherein the valve includes:
a hydraulic cylinder that encloses a shaft; and
a piston that moves within the shaft and transfers motion to a movable knife, wherein, in response to the piston movement, the movable knife closes or opens the valve.

20. The system of claim 19, wherein, when the valve is closed, the movable knife blocks an aperture that enables passage of the first amount of feedstock.

21. The system of claim 20, wherein the valve includes a valve housing that couples the valve to the collection vessel and the accumulation chamber.

22. The system of claim 21, wherein the valve housing includes a gate enclosure that comprises the movable knife.

23. The system of claim 22, wherein fluid circulates continuously or nearly continuously from a first end of the valve to a second end of the valve, the fluid circulates at least through the shaft and the gate enclosure.

24. The system of claim 12, wherein the structure that enables recovery of atmospheric pressure in the collection vessel includes:
a compressor that pressurizes a volume of air;
a valve that regulates flow of gas to the collection vessel; and
an air cannon functionally coupled to the compressor and the valve, wherein the air cannon blasts at least a portion of the pressurized volume of air to the collection vessel.

25. The system of claim 12, wherein the first injection apparatus includes:
a valve that regulates flow of the synthesis gas towards the collection vessel;
a compressor coupled to the valve and that circulates the synthesis gas to the collection vessel; and
a gas plenum assembly coupled to the valve and that enables injection of the synthesis gas into the collection vessel.
